(19) United States
(12) Patent Application Publication
(10) Pub. No.: US 2024/0407056 A1
(43) Pub. Date: Dec. 5, 2024

(54) FLEXIBLE HEATER

(71) Applicant: KOREA ADVANCED INSTITUTE OF SCIENCE AND TECHNOLOGY, Daejeon (KR)

(72) Inventors: Ki-Uk KYUNG, Daejeon (KR); Minki Kim, Daejeon (KR)

(73) Assignee: KOREA ADVANCED INSTITUTE OF SCIENCE AND TECHNOLOGY, Daejeon (KR)

(21) Appl. No.: 18/660,541

(22) Filed: May 10, 2024

(30) Foreign Application Priority Data
Jun. 2, 2023 (KR) 10-2023-0071848
Sep. 14, 2023 (KR) 10-2023-0122613

(51) Int. Cl. H05B 3/12; H05B 3/34

(52) U.S. Cl. CPC H05B 3/12; H05B 3/34

(57) ABSTRACT

Provided is a flexible heater. The flexible heater includes a first electrode, a second electrode arranged to be spaced apart from the first electrode, and a dielectric gel layer arranged between the first electrode and the second electrode and generating heat in response to an alternating voltage applied thereto.

### CROSS-REFERENCE TO RELATED APPLICATIONS

This application is based on and claims priority under 35 U.S.C. § 119 to Korean Patent Application Nos. 10-2023-0071848, filed on Jun. 2, 2023, and 10-2023-0122613, filed on Sep. 14, 2023, in the Korean Intellectual Property Office, the disclosures of which are incorporated by reference herein in their entirety.

### BACKGROUND

### 1. Field

The disclosure relates to a heater, and more particularly, to a flexible heater.

The research was conducted with the support of Samsung Future Technology Promotion Project (task no.: SRFC-IT2102-04).

### 2. Description of the Related Art

In general, a heater generates heat by using a thermal resistance method. For example, a heater can induce heat generation in response to a high current applied to an electrode with excellent electrical conductivity.

Devices using a thermal resistance method may be divided into two types according to the material and shape of a heating element. Firstly, a heater may be manufactured by applying highly conductive nanomaterials, such as metal nanowires and metal nanofibers, on a flexible substrate.

Secondly, an electrode material, such as a serpentine, wrinkle, mesh, or kirigami structure, may be manufactured into a flexible and stretchable structure to be used as a heater.

A heater of a thermal resistance type cannot generate heat locally because heat is generated throughout an electrode. Also, when an electrode density is increased, transparency and flexibility of the electrode decrease, and when the electrode density is decreased, the conductivity of the electrode is damaged.

### SUMMARY

Provided is a flexible heater including a dielectric gel layer with high flexibility.

Additional aspects will be set forth in part in the description which follows and, in part, will be apparent from the description, or may be learned by practice of the presented embodiments of the disclosure.

According to an aspect of the disclosure, a flexible heater includes a first electrode, a second electrode arranged to be spaced apart from the first electrode, and a dielectric gel layer arranged between the first electrode and the second electrode and generating heat in response to an alternating voltage applied thereto, wherein the dielectric gel layer has a dielectric loss value of 10 or more at an frequency of the alternating voltage of 1,000 Hz or less.

Also, the dielectric gel layer may include a polymer network and plasticizers dispersed in the polymer network.

In addition, the polymer network may include at least one of a co-polymer and a block co-polymer of polyvinyl chloride (PVC)-based, polystyrene (PS)-based, polymethyl methacrylate (PMMA)-based, polyvinylidene fluoride-based, polybutene (PB)-based.

Also, the plasticizers may include at least one of dibutyl adipate (DBA), dimethyl phthalate(DMP), diethyl phthalate (DEP), dibutyl phthalate (DBP), bis(2-ethylhexyl) phthalate (DEHP), diisodecyl phthalate (DIDP), diisononyl phthalate (DINP), bis(2-ethylhexyl) terephthalate (DOTP), diisodecyl adipate (DIDA), dimethyl adipate(DMA), dietyl adipate (DEA), dipropyl adipate (DPA), bis(2-ethylhexyl)adipate (DOA), diisopropyl adipate (DIPA), dacetyl tributyl citrate (ATBC), dibutyl sebacate (DBS), dioctyl sebacate (DOS), dioctyl Maleate (DOM), 1,2-Cyclohexane dicarboxylic acid diisononyl ester (DINCH) and tris(2-ethylhexyl)trimellitate (TOTM).

In addition, a weight of the plasticizers in the dielectric gel layer may be greater than a weight of the polymer network.

Also, a weight ratio of the plasticizers to the polymer network may be greater than 2 and 14 or less.

In addition, the dielectric gel layer may generate heat by a periodic movement of the plasticizers in the dielectric gel layer in response to the alternating voltage applied thereto.

Also, the movement of the plasticizers may include at least one of a rotational movement, a vibration movement, and a linear movement of the plasticizers.

In addition, the dielectric gel layer may have a thermal conductivity of 0.5 W/mk or less.

Also, a temperature of the dielectric gel layer may no longer increase once the temperature of the dielectric gel layer reaches a saturation temperature.

In addition, when an operational frequency of the alternating voltage is a frequency of a zero-phase angle impedance or more, the saturation temperature may be proportional to an intensity of the alternating voltage regardless of the operational frequency of the alternating voltage.

Also, the frequency of the zero-phase angle impedance may be included in a range of at least 10 Hz but not more than 1000 Hz.

In addition, a ratio of a minimum temperature to a maximum temperature in an area of the dielectric gel layer may be 0.8 or more.

Also, at least one of the first and second electrodes may include at least one of a conductive hydrogel, a conductive oxide, a carbon˜based conductive material, a conductive polymer, and a metal.

In addition, at least one of the first and second electrodes may include at least one of a conductive particle and an electrolyte.

Also, at least one of the first and second electrodes may further include a crosslinking agent that is covalently cross-linked with the dielectric gel layer.

In addition, the flexible heater may have a light transmittance of 70% or more in a visible light area.

Also, a strain rate of the flexible heater may be 100% or more.

In addition, the first electrode may include a plurality of first sub-electrodes arranged to be spaced apart from each other in a first direction, and the dielectric gel layer may selectively generate heat in an area overlapping the plurality of first sub-electrodes and the second electrode in a thickness direction of the dielectric gel layer.

Also, the second electrode may include a plurality of second sub-electrodes arranged to be spaced apart from each other in a second direction that is different from the first direction.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional view illustrating a flexible heater according to an embodiment;

FIG. 2A is a diagram illustrating a flexible heater when an alternating voltage is not applied thereto, according to an embodiment;

FIG. 2B is a diagram illustrating a flexible heater when an alternating voltage is applied thereto, according to an embodiment;

FIG. 3 is a graph showing dielectric loss according to a plasticizer ratio according to an embodiment;

FIG. 4 is a result showing electrical impedance characteristics of a dielectric gel layer according to an embodiment;

FIG. 5 is a result showing heat generation characteristics of a dielectric gel layer according to an operational frequency, according to an embodiment;

FIG. 6 is a graph showing heat generation characteristics according to an intensity of an alternating voltage according to an embodiment;

FIG. 7 is a result showing a temperature change when a voltage is repeatedly applied to a dielectric gel layer according to an embodiment;

FIG. 8 is a graph showing a temperature distribution for each position of a dielectric gel layer according to an embodiment;

FIG. 9 is a diagram showing thermal characteristics according to a strain rate of a flexible heater according to an embodiment;

FIG. 10 is a graph showing a temperature and current according to modification of a flexible heater according to an embodiment;

FIG. 11 is a graph showing light transmittance of a flexible heater from ultraviolet to near Infrared range according to an embodiment;

FIG. 12 is a diagram showing a flexible heater that generates heat locally according to an embodiment;

FIG. 13 is a block diagram including an equivalent circuit of the flexible heater shown in FIG. 12;

FIG. 14 is a diagram showing a partial cross-sectional area including unit cells included in the flexible heater of FIG. 12;

FIG. 15 is a diagram showing results of an experiment after manufacturing the flexible heater of FIG. 12;

FIG. 16 is a diagram illustrating a flexible heater including a sub-electrode according to an embodiment; and

FIG. 17 is a diagram illustrating a flexible heater including an insulating layer according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The disclosure will now be described more fully with reference to the accompany drawings, in which embodiments of the disclosure are shown. Like reference numerals in the drawings denote like elements, and sizes of components in the drawings may be exaggerated for convenience of explanation. The disclosure may, however, be embodied in many different forms and should not be construed as being limited to the embodiments set forth herein.

Hereinafter, a case where a position relationship between two items is described with the terms “on˜,” “on the top of˜,” or the like, may include not only a case where one item is positioned above, below, on the left side, and on the right side of another item with direct contact, but also a case where one items is positioned above, below, on the left side, and on the right side of another item without any contact. An expression used in the singular encompasses the expression of the plural, unless it has a clearly different meaning in the context. Alternatively, when a portion “includes” an element, another element may be further included, rather than excluding the existence of the other element, unless otherwise described.

The use of the terms “a” and “an” and “the” and similar referents in the context of describing the disclosure are to be construed to cover both the singular and the plural. The steps of all methods described herein can be performed in any suitable order unless otherwise indicated herein or otherwise clearly contradicted by context.

Also, the terms “units” and “modules” used herein may refer to units that perform at least one function or operation, and the units may be implemented as hardware or software or a combination of hardware and software.

The connecting lines, or connectors shown in the various figures presented are intended to represent functional relationships and/or physical or logical couplings between the various elements. It should be noted that many alternative or additional functional relationships, physical connections or logical connections may be present in a practical device.

Expressions such as “at least one of,” when preceding a list of elements, modify the entire list of elements and do not modify the individual elements of the list. For example, expressions such as “at least one of A, B, and C” or “at least one selected from the group consisting of A, B, and C” may be interpreted as A only, B only, C only, or ABC, or a combination of two or more of A, B, and C such as AB, BC and AC.

It shall be understood that manufacturing or operating variations (e.g., ±10%) are possible around state values in related values when the descriptions are given with the terms “about,” “substantially,” in relation to numbers. Alternatively, when the terms “generally” and “substantially” are used in relation to geometric shapes, it may be intended that geometrical constraints are not required and that latitude for the shape is within the scope of the disclosure. Alternatively, whether or not the values or figures are limited to “about” or “substantially,” such values and figures are to be construed to include manufacturing or operating variations (e.g., ±10%) around the stated values.

While such terms as “first,” “second,” etc., may be used to describe various components, such components must not be limited to the above terms. The above terms are used only to distinguish one component from another.

The terms used in the disclosure are merely used to describe particular embodiments, and are not intended to limit the disclosure.

Hereinafter, the embodiments will now be described more fully with reference to the accompany drawings.

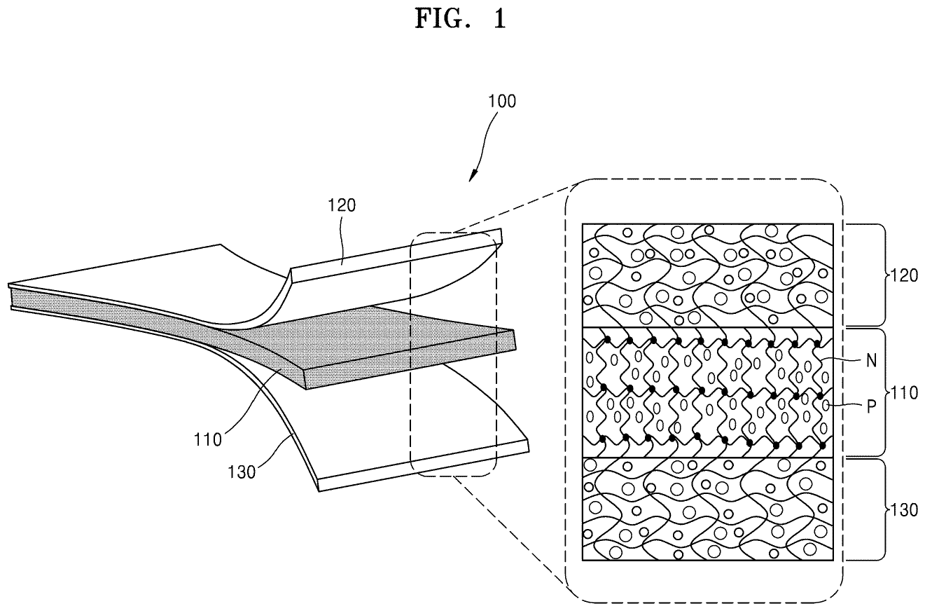

FIG. 1 is a cross-sectional view illustrating a flexible heater 100 according to an embodiment. Referring to FIG. 1, the flexible heater 100 may include a dielectric gel layer 110, a first electrode 120, and a second electrode 130, wherein the first and second electrodes 120 and 130 are arranged to be spaced apart from each other with the dielectric gel layer 110 therebetween and apply alternating voltages to the dielectric gel layer 110.

In an embodiment, the dielectric gel layer 110 may include a transparent material. For example, the dielectric gel layer 110 may include a material having a transmittance of 70% or more or 75% or more in a visible light region.

In an embodiment, the dielectric gel layer 110 may include a material with a high strain rate. The strain rate of the dielectric gel layer 110 may be about 100% or more. For example, the strain rate of the dielectric gel layer 110 may be about 100% or more and about 500% or less. The strain rate may refer to a vertical or linear strain rate. For example, a strain rate may be a value obtained by dividing a difference between a length of the dielectric gel layer 110 that is modified and a length of the original dielectric gel layer 110 by the length of the original dielectric gel layer 110 when a tensile stress is applied to the dielectric gel layer 110 to stretch the dielectric gel layer 110 in a longitudinal direction, that is, a direction perpendicular to a thickness of the dielectric gel layer 110. For example, the strain rate of the dielectric gel layer 110 may be about 100% or more and about 500% or less.

In an embodiment, the dielectric gel layer 110 may include a material that generates heat by an alternating voltage applied to the dielectric gel layer 110. A dielectric loss value of the dielectric gel layer 110 may be large. The dielectric loss value of the dielectric gel layer 110 may be inversely proportional to an operational frequency of an alternating voltage. For example, the dielectric loss value of the dielectric gel layer 110 may be proportional to a reciprocal of the operational frequency. Nevertheless, the dielectric loss value of the dielectric gel layer 110 may be about 10 or more at an operational frequency of about 1,000 Hz or less. Alternatively, the dielectric loss value of the dielectric gel layer 110 may be about 100 or more at an operational frequency of about 100 Hz or less.

In an embodiment, the dielectric gel layer 110 may include a material with low thermal conductivity. For example, the dielectric gel layer 110 may have a thermal conductivity of about 0.5 W/mk or less. Because the dielectric gel layer 110 has a large dielectric loss value and low thermal conductivity, heat may be generated only in a particular region of the dielectric gel layer 110.

In an embodiment, even when heat is generated in the dielectric gel layer 110 by an alternating voltage, the temperature of the dielectric gel layer 110 may no longer increase once the temperature of the dielectric gel layer 110 reaches a saturation temperature in a particular operational frequency of the alternating voltage. The temperature of the dielectric gel layer 110 may mean an average temperature of the dielectric gel layer 110. The saturation temperature described above may be about 80° C. or less.

The saturation temperature may be independent of a frequency of an alternating voltage over a particular frequency range, for example, a frequency of a zero-phase angle impedance. The saturation temperature may be proportional to an intensity of an alternating voltage. For example, the saturation temperature may be proportional to the square of an intensity of an alternating voltage. A frequency of the zero-phase impedance may be about 10 Hz or more and about 1000 Hz or less.

The saturation temperature may be proportional to an intensity of an alternating voltage. For example, the saturation temperature may be proportional to the square of an intensity of an alternating voltage. The intensity of the alternating voltage may be 1000 V or less. Herein, the intensity of the alternating voltage may mean a maximum intensity of the alternating voltage.

A time for the dielectric gel layer 110 to reach a saturation temperature is weakly dependent on the frequency and intensity of an alternating voltage, and may be inversely proportional to a thickness of the dielectric gel layer 110. For example, the time for the dielectric gel layer 110 to reach the saturation temperature may be about 200 seconds or less or about 100 seconds or less. Because the time to reach a saturation temperature is less related to the frequency and intensity of an alternating voltage, when an alternating voltage is applied to the flexible heater 100 according to an embodiment, it is expected that the saturation temperature will be reached in a particular time.

In an embodiment, the dielectric gel layer 110 may include a polymer network N and plasticizers P dispersed in the polymer network N. The polymer network N may include a material that maintains a three-dimensional structure of the dielectric gel layer 110 while having dielectric characteristics. For example, the polymer network N may include at least one of a co-polymer and a block co-polymer of polyvinyl chloride (PVC)-based, polystyrene (PS)-based, polymethyl methacrylate (PMMA)-based, polyvinylidene fluoride-based, and polybutene (PB)-based.

A plasticizer P may include an electric dipole. For example, the plasticizer P may include at least one of dibutyl adipate (DBA), dimethyl phthalate(DMP), diethyl phthalate (DEP), dibutyl phthalate (DBP), bis(2-ethylhexyl) phthalate (DEHP), diisodecyl phthalate (DIDP), diisononyl phthalate (DINP), bis(2-ethylhexyl) terephthalate (DOTP), diisodecyl adipate (DIDA), dimethyl adipate(DMA), dietyl adipate (DEA), dipropyl adipate (DPA), bis(2-ethylhexyl)adipate (DOA), diisopropyl adipate (DIPA), dacetyl tributyl citrate (ATBC), dibutyl sebacate (DBS), dioctyl sebacate (DOS), dioctyl Maleate (DOM), 1,2-Cyclohexane dicarboxylic acid diisononyl ester (DINCH) and tris(2-ethylhexyl)trimellitate (TOTM).

In general, when the plasticizer P is included in the polymer network N, a distance between the polymer networks N may become distant, and the dielectric gel layer 110 becomes a state like gel having dielectric properties instead of a hard solid. As the plasticizer P moves in response to an applied alternating voltage, heat may be generated in the dielectric gel layer 110. Heat generation of the dielectric gel layer 110 will be described below.

A weight of the plasticizer P included in the dielectric gel layer 110 may be greater than a weight of the polymer network N. For example, a weight ratio of the plasticizer P to the polymer network N may be greater than about 2 and less than about 10. Alternatively, the weight ratio of the plasticizer P to the polymer network N may be at least about 2 but not more than about 10. Heat generation increases as more plasticizers P are contained in the dielectric gel layer 110, but the movement of the plasticizer P may be restricted by neighboring plasticizers P when the amount of the plasticizers P exceeds a certain amount.

The first and second electrodes 120 and 130 may be arranged with the dielectric gel layer 110 therebetween. For example, the first electrode 120 may be arranged on an upper surface of the dielectric gel layer 110, and the second electrode 130 may be arranged on a lower surface of the dielectric gel layer 110.

Each of the first and second electrodes 120 and 130 may include a material with high electrical conductivity. In an embodiment, each of the first and second electrodes 120 and 130 may include a flexible and transparent material. Because all of the dielectric gel layer 110 and the first and second electrodes 120 and 130 include flexible and transparent materials, the flexible heater 100 according to an embodiment may also be flexible and transparent.

At least one of the first and second electrodes 120 and 130 may include a conductive hydrogel. A conductive hydrogel is a three-dimensional network structure in which polymers are physically and chemically cross-linked to each other, which may not dissolve in an aqueous environment and may contain a significant amount of water. A hydrogel has excellent flexibility. The hydrogel may have excellent conductivity by dispersing conductive particles in the hydrogel.

In an embodiment, a conductive hydrogel may include at least one of a polymer, monomeric saccharides including one or more disaccharides or monosaccharides, and a crosslinking agent and may have a polymer network structure in which the polymer and monomeric saccharides are cross-linked to each other by the crosslinking agent.

The polymer may include one or more selected from a group consisting of polyvinyl alcohol (PVA), polyvinyl acetate (PVAc), polyethylene glycol (PEG), polypropylene glycol (PPG), polyhydroxyethylmethacrylate (polyHEMA), polyacrylamide, polyvinyl pyrrolidone (PVP), poly(acrylic acid) (PAA), and co-polymers thereof.

The monomeric saccharides may encompass monosaccharides and disaccharides, and may include, for example, one or more disaccharides selected from a group consisting of sucrose, lactose, and maltose.

The crosslinking agent may include, for example, one or more selected from a group consisting of borates, dialdehydes, dicarboxylic acids, and diols.

A conductive hydrogel may include conductive particles. The conductive particles may include at least one of an electrolyte, metal oxide nanoparticles, metal nanoparticles, and nanocarbon particles. For example, the electrolyte may include, for example, lithium chloride. The metal oxide nanoparticles may include one or more of transparent conductive oxide and transition metal oxide, and may include, for example, one or more from among indium tin oxide (ITO), fluorine-doped tin oxide (FTO), indium zinc oxide (IZO), aluminium-doped zinc oxide (AZO), gallium zinc oxide (GZO), indium gallium tin oxide (IGTO), indium gallium zinc oxide (IGZO), RuO2, MnO2, Mn3O4, Co3O4, TiO2, ZnO, NiO, or the like.

A crosslinking agent included in at least one of the first and second electrodes 120 and 130 may covalently cross-link the dielectric gel layer 110 to at least one of the first and second electrodes 120 and 130. When each of the first and second electrodes 120 and 130 includes a conductive hydrogel, the hydrogel may be a hydrophilic material. On the contrary, the dielectric gel layer 110 may include a hydrophobic material. An interface between the dielectric gel layer 110 and electrodes may have a low adhesion strength due to materials having different characteristics. In an embodiment, as crosslinking agents included in electrodes may covalently cross-link materials with different characteristics, an adhesion strength of an interface between the dielectric gel layer 110 and the electrodes may be increased. Covalent cross-linking at the above interface may be formed by a swelling-driven surface absorption method. Accordingly, the flexible heater 100 may maintain a solid interface at an interface between the dielectric gel layer 110 and the electrodes even during stretching.

FIG. 1 shows a conductive hydrogel as each of the first and second electrodes 120 and 130, but the disclosure is not limited thereto. In an embodiment, at least one of the first and second electrodes 120 and 130 may include a transparent and flexible material such as graphene, silver nanowire, a conductive polymer, conductive oxide, a carbon˜based conductive material, metal, or the like. For example, at least one of the first and second electrodes 120 and 130 may include a conductive material having a stretchable structure, such as a serpentine, wrinkle, mesh, or kirigami structure.

In an embodiment, the flexible heater 100 may locally control heat generation because heat is generated in the dielectric gel layer 110. Also, the dielectric gel layer 110 may not rise above a saturation temperature.

As a comparative example, there is a heater that generates heat from a flexible electrode. For example, a heater may be manufactured by applying silver nanowires (AgNW) on a flexible substrate, such as polydimethylsiloxane (PDMS). The heater has an uneven temperature distribution due to heat generation being partially occurred as a length of the heater is extended, and the heater has a low tensile strain rate up to 60%. Also, temperature uniformity of the heater may be improved by increasing an amount of silver nanowires applied on the flexible substrate, but at the same time, the transmittance of the heater is reduced and the turbidity (haze) thereof increases, resulting in a decrease in optical characteristics of the heater.

Alternatively, there is a heater obtained by combining a surface wrinkle structure with a carbon nanotube (CNT) material that is flexible and may create a uniform temperature distribution in the heater. In the above heater, a carbon nanotube material is applied on a flexible substrate in a state where the flexible substrate is stretched long, and then a wrinkle structure may be formed on the surface of the flexible substrate when the flexible substrate is returned to its original length. At this time, due to the surface wrinkle structure and the carbon nanotubes arranged along wrinkles, heat may be generated even when the flexible substrate is stretched long. Although the transmittance of the heater may be improved by reducing an amount of carbon nanotubes, in the case of a low applying amount of carbon nanotubes, a distance between the carbon nanotubes increases in a state in which the heater is stretched long, and contact points of the carbon nanotubes decrease, resulting in an increase in a resistance value of the heater. This reduces heat generation intensity of the heater and limits a strain rate of the heater.

Alternatively, a transparent heater may be manufactured by coating aluminum conductive ink and single walled carbon nanotubes (SWCNT) on a flexible substrate (polyimide, PET). The transparent heater is difficult to manufacture because the SWCNTs are aggregated and must be separated by using surfactants and ultrasound before spray coating. Also, as the coating amount of conductive ink and SWCNTs used increases, a strain rate and a heat generation intensity of the transparent heater increase, but the permeability of the transparent heater decreases.

As another comparative example, a heater may be manufactured by using a selective electroplating operation of electroplating a thin copper (Cu) mesh electrode on a flexible substrate (polyethylene terephthalate, PET). In this case, because a tightly arranged mesh structure is used, tension is possible and a uniform temperature distribution may be formed throughout the heater. However, an operation of manufacturing a mesh structure is essential and varies depending on an electrode material used, and there are difficulties in manufacturing the mesh structure. Also, when tension occurs, electrodes forming a mesh are easily broken, and a strain rate of the heater is limited to about 70%.

As another comparative example, a heater may be manufactured by making a flat electrode plate into a shape of a kirigami structure. Alternatively, a kirigami structure may be manufactured by apply AgNWs on a transparent flexible substrate and then performing laser-ablation on the transparent flexible substrate with the AgNWs applied thereon by using ultraviolet rays (UV 365 nm). The above electrode structure has structurally wide-open areas that repeatedly exist, so that the heater is easily stretched long, but heat is generated only in places arranged with electrodes, and thus uneven temperature distribution is formed.

While the heater described as a comparative example generates heat at the electrode, the flexible heater 100 according to an embodiment has a different operational principle in that heat is generated in a dielectric gel layer, which is a dielectric.

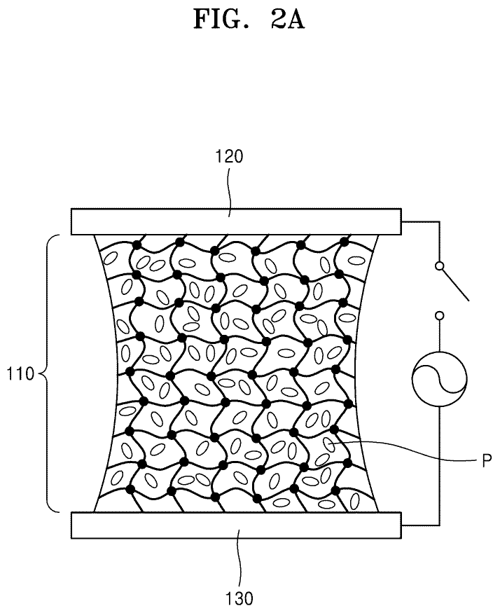

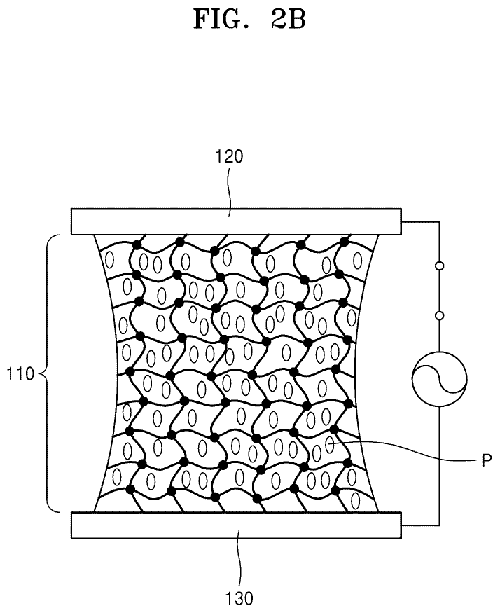

FIGS. 2A and 2B are diagrams explaining an operational principle of the flexible heater 100 according to an embodiment.

As shown in FIG. 2A, when an electric field is not applied to the flexible heater 100, the plasticizers P included in the dielectric gel layer 110 may be randomly arranged.

A voltage may be applied to the dielectric gel layer 110 of the flexible heater 100 through the first and second electrodes 120 and 130. The voltage may be an alternating voltage. When an alternating voltage is applied to the dielectric gel layer 110 through the first and second electrodes 120 and 130, an alternating electric field may be formed in the dielectric gel layer 110.

As shown in FIG. 2B, the plasticizers P arranged in the dielectric gel layer 110 may be aligned in a direction of the electric field. As the alternating voltage changes the intensity and direction of the electric field formed in the dielectric gel layer 110, the plasticizers P may also periodically or repeated move in response to the intensity and direction of the electric field. For example, the plasticizers P may move in at least one method of rotational movement, vibration movement, and linear movement.

The movement of the plasticizers P may induce heat generation in the dielectric gel layer 110. That is, electrical energy applied to the dielectric gel layer 110 may be converted to thermal energy by the movement of the plasticizers P. The thermal energy may be related to a dielectric loss value of the dielectric gel layer 110 and an alternating voltage. The dielectric loss value may be related to at least one of an alternating voltage and a weight ratio of the plasticizer P to the polymer network N included in the dielectric gel layer 110. The alternating voltage may be related to an operational frequency and intensity.

In an embodiment, thermal energy of the dielectric gel layer 110 may be proportional to an intensity of an alternating voltage at a frequency or higher of a zero-phase angle impedance. For example, the thermal energy of the dielectric gel layer 110 may be proportional to the square of the intensity of the alternating voltage. In the Nyquist plot of the dielectric gel layer 110, a frequency of the zero-phase angle impedance may be about 10 Hz or more. Alternatively, the frequency of the zero-phase angle impedance may be about 1000 Hz.

When a frequency of alternating power input to the dielectric gel layer 110 is the frequency of the zero-phase angle impedance or higher, as an equivalent circuit of the dielectric gel layer 110 is a parallel connection of a resistor and a capacitor, power (P) of the dielectric gel layer 110 may be expressed as Equation 1 below.

$$P = VI = {ε}_{0} {ε}_{r}^{″} ( T , f ) \frac{A}{d} {wV}^{2} \qquad [ Equation 1 ]$$

Herein, V is a voltage applied to the dielectric gel layer 110, I is a current flowing in the dielectric gel layer 110, ε₀ is a vacuum permittivity of the dielectric gel later 110, εᵣ″ is a dielectric gel layer 110, A is a heat generation area of the dielectric gel layer 110, d is a thickness of the dielectric gel layer 110, and w is an angular frequency of the dielectric gel layer 110. The dielectric loss value (εᵣ″) of the dielectric gel layer 110 is a function of the temperature of the dielectric gel layer 110 and a frequency of a voltage applied to the dielectric gel layer 110.

As the power applied to the dielectric gel layer 110 is converted into thermal energy, heat generated in the dielectric gel layer 110 may be affected by the applied voltage, the dielectric loss value of the dielectric gel layer 110, geometric factors (e.g., area and thickness) of the dielectric gel layer 110, as shown in Equation 1.

When the dielectric loss value is inversely proportional to an operational frequency of an alternating voltage, for example, when the dielectric loss value is proportional to a reciprocal of the operational frequency of the alternating voltage, the dielectric loss value may be expressed as Equations 2 and 3.

$${ε}_{r}^{″} ( f ) ∝ \frac{1}{f} , \qquad [ Equation 2 ]$$

$$at constant T$$

$${ε}_{r}^{″} ( T , f ) = {ε}_{r , Temp}^{″} ( T ) {ε}_{r , freq}^{″} ( f ) = {ε}_{r , Temp}^{″} ( T ) \frac{α}{f} ,$$

where α is a constant.

When Equation 3 is substituted into Equation 1, the power P of the dielectric gel layer 110 is as shown in Equation 4.

$$P = {ε}_{0} {ε}_{r}^{″} ( T , f ) \frac{A}{d} {wV}^{2} = {ε}_{0} {ε}_{r , Temp}^{″} ( T ) α \frac{A}{d} 2 π {V}^{2} ,$$

where f>zero−phase angle freq

At a frequency at which the Nyquist plot of the dielectric gel layer 110 draws a semicircle, that is, a frequency of the zero-phase angle impedance, the power of the dielectric gel layer 110, that is, the thermal energy may be proportional to a voltage. For example, at the frequency of the zero-phase angle impedance, the power of the dielectric gel layer 110, that is, the thermal energy may be directly proportional to the square of the voltage.

In a frequency range where an impedance draws a semicircle, as heat of the dielectric gel layer 110 is proportional to the intensity of an alternating voltage without being related to a frequency of the alternating voltage, the heat generation characteristics of the flexible heater 100 may be controlled by adjusting the intensity of the alternating voltage. This may facilitate control of the flexible heater 100.

Even the flexible heater 100 according to an embodiment generates heat, the temperature of the flexible heater 100 no longer increases when the temperature of the flexible heater 100 reaches a saturation temperature. This allows the flexible heater 100 to operate stably.

A temperature time constant of the flexible heater 100 may be affected by the thickness of the dielectric gel layer 110.

A time constant of the dielectric gel layer 110 according to an embodiment is as shown in Equation 5 below.

$$τ = \frac{C ρ d}{h - \frac{1}{2} {ε}_{0} β ( 2 π α ) \frac{{V}_{0}^{2}}{d}} \qquad [ Equation 5 ]$$

Here, C is the specific heat capacity of the dielectric gel layer 110, p represents the density of the dielectric gel layer 110, and h and β are respectively a heat transfer coefficient and a temperature coefficient of dielectric loss of the dielectric gel layer 110. By reducing the thickness of the dielectric gel layer 110, a heating rate of the dielectric gel layer 110 may be increased and an input voltage may be lowered to reach a saturation temperature.

Reaching a saturation temperature may mean that the flexible heater 100 may provide a constant temperature and reach the same temperature even when heating and non-heating are repeatedly performed.

Hereinafter, the flexible heater 100 according to an embodiment is manufactured and results of measuring the characteristics thereof are described.

### A Method of Manufacturing a Flexible Heater

A dielectric gel layer may be formed by homogeneously stirring dielectric polymer powder, for example, PVC powder, and DBA that is a plasticizer in a tetrahydrofuran (THF) solvent. A weight ratio of the plasticizer to a dielectric polymeric material may exceed 1. For example, the weight ratio of the plasticizer to the dielectric polymeric material may be 6. After the dielectric polymer powder is completely dissolved, the solvent is evaporated, so that a highly elastic and transparent dielectric gel layer may be obtained.

The dielectric gel layer may be prepared on a hydrophobic glass substrate.

Surface treatment may be performed on the dielectric gel layer. In the surface treatment, an ethanol solution including 5 wt % benzophenone may be used. The benzophenone remained after evaporating ethanol may be washed with ethanol.

An electrode material may be applied on the dielectric gel layer on which the surface treatment is performed. The electrode material may be a conductive hydrogel solution. Here, as the conductive hydrogel solution, 8 wt % acrylamide (AAm) 0.021 wt % N,N-methylenebisacrylamide (MBAA), and 23.8 wt % lithium chloride (LiCl) as solutes and 0.056 wt % deionized water (DI water) as a solvent may be used. AAm may act as a main monomer forming a main network of a hydrogel, and MBAA may function as a crosslinking agent. LiCl may be used as an electrolyte to prevent hydration and provide conductivity to the hydrogel. A first electrode may be formed by applying a conductive hydrogel solution to a dielectric gel layer and then forming a conductive hydrogel covalently cross-linked with the dielectric gel layer by using a swelling-driven surface absorption method. The above swelling-driven surface absorption method may be performed by irradiation of ultraviolet light.

A second electrode may be formed on another side of the dielectric gel layer by the same method.

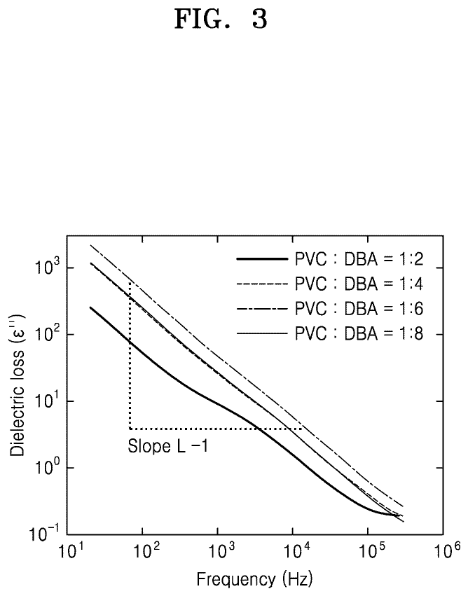

FIG. 3 is a graph showing dielectric loss values according to a plasticizer ratio according to an embodiment. PVC was used as a polymer network, and DBA was used as a plasticizer. As shown in FIG. 3, it may be confirmed that the dielectric loss value varied according to a weight ratio of the plasticizer to the polymer network. A weight (wt %) of the plasticizer in a dielectric gel layer may be greater than a weight of the polymer network. For example, the weight ratio of plasticizer to the polymer network may be greater than about 2. It may be confirmed that a dielectric gel layer in which the weight ratio of the plasticizer to the polymer network was greater than about 2 had a dielectric loss value or 100 or more at an operational frequency of 100 Hz or less.

Also, as the weight ratio of the plasticizer to the polymer network increases, the dielectric loss value increases, and it may be confirmed that the dielectric loss value was maximum when the weight ratio of the plasticizer to the polymer network was 6. According to an embodiment, a weight ratio of a plasticizer to a polymer network may be greater than about 2 and less than about 14. Alternatively, according to an embodiment, the weight ratio of the plasticizer to the polymer network may be at least about 4 but not more than about 8.

Also, the dielectric loss value may vary according to an operational frequency. For example, the dielectric loss value may decrease as the operational frequency increases. In particular, when the weight ratio of the plasticizer to the polymer network is at least about 4 but not more than about 8, it may be confirmed that the dielectric loss value of the dielectric gel layer was directly proportional to a reciprocal of the operational frequency. In addition, it may be confirmed that the dielectric loss value of the dielectric gel layer was 10 or more when the operational frequency was 1000 Hz or less.

When the operational frequency is low, the dielectric gel layer may have decreased heat generation efficiency despite a high dielectric loss value.

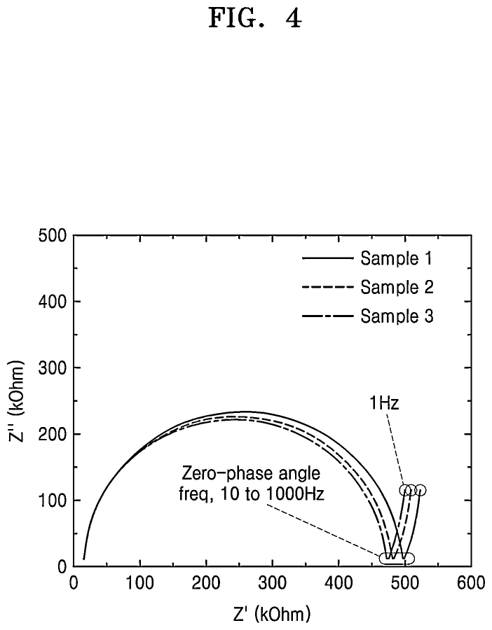

FIG. 4 is a result showing electrical impedance characteristics of a dielectric gel layer according to an embodiment. PVC was used as a polymer network of a dielectric gel layer, and DBA was used as a plasticizer. A weight ratio of the plasticizer to the polymer network is at least about 4 but not more than about 8. Three samples, that is, the same dielectric gel layer, were fabricated, and electrical impedances of the three samples were measured. Electrical impedance was measured by apply an alternating voltage of 5 V to a dielectric gel layer in a frequency range of 1 Hz to 100 Hz.

As shown in FIG. 4, it may be confirmed that the zero-phase angle impedance began and drew a semicircle in a frequency range of at least about 10 Hz but not more than about 1000 Hz. The semicircle in an impedance spectrum means that an equivalent circuit of the dielectric gel layer is a parallel structure of a resistor and a capacitor.

Accordingly, in a frequency range of the zero-phase angle impedance, for example, a frequency range of at least about 10 Hz but not more than about 1000 Hz, heating characteristics of the dielectric gel layer may be related to an intensity of an alternating voltage and may have weak relationship with a frequency of the alternating voltage. For example, in a frequency range where the zero-phase angle impedance draws a semicircle, heat generated in the dielectric gel layer may be proportional to the intensity of the alternating voltage.

FIG. 4 shows results of measuring electrical impedance in a frequency range of at least 1 Hz but not more than 100 kHz, and it may be confirmed that the frequency range in which the zero-phase angle impedance drew a semicircle was at least 10 Hz but not more than 1000 Hz.

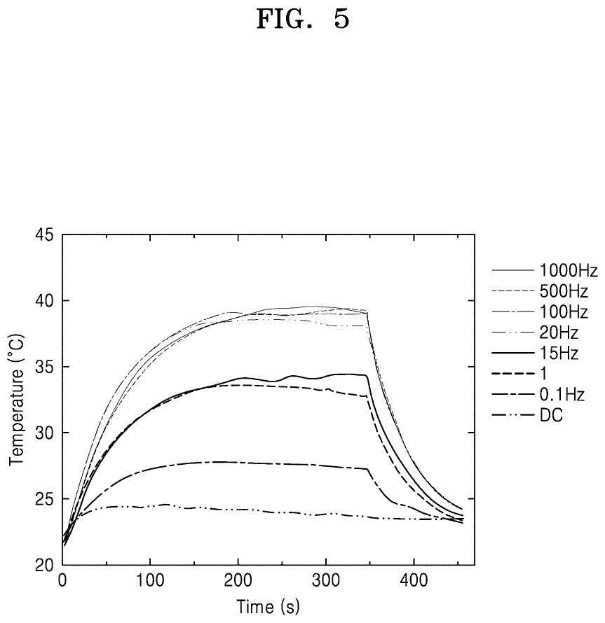

FIG. 5 is a result showing heat generation characteristics of a dielectric gel layer according to an embodiment according to an operational frequency. PVC was used as a polymer network of a dielectric gel layer, and DBA was used as a plasticizer. A weight ratio of the plasticizer to the polymer network is at least about 4 but not more than about 8. A thickness of the dielectric gel layer was about 650 μm, and an alternating voltage of 600 V was applied to the dielectric gel layer for about 300 seconds.

Referring to FIG. 5, it may be confirmed that as an operational frequency decreased, the heat generation characteristics of the dielectric gel layer decreased. The heat generation characteristics may be inversely proportional to an operational frequency. Even when a direct voltage is applied, plasticizers may momentarily move due to an electric field, and heat may be generated. However, it may be confirmed that the movement of the plasticizers was weak, and heating performance of the dielectric gel layer was significantly low. It may be confirmed that the heat generation characteristics of the dielectric gel layer were proportional to a dielectric loss value but are also proportional to an operational frequency. Accordingly, heat generation characteristics of a flexible heater may be controlled by setting an appropriate operational frequency.

Also, it may be confirmed that a heat generation temperature of the dielectric gel layer was 10 degrees or more when the operational frequency was about 1 Hz or more. Here, the heat generation temperature may be a difference between a temperature of the dielectric gel layer, which is raised when an alternating voltage is applied to the dielectric gel layer, and a temperature of the dielectric gel layer in a state in which the alternating voltage is not applied to the dielectric gel layer.

In an embodiment, the temperature of the dielectric gel layer may no longer increase once the temperature of the dielectric gel layer reaches a saturation temperature even where an alternating voltage is continuously applied. In particular, it may be confirmed that the dielectric gel layer had almost the same temperature profile at an operational frequency of at least 20 Hz but not more than about 1000 Hz. That is, it may be confirmed that the saturation temperature and a heating rate or the were constant regardless of the operational frequency of the alternating voltage in a frequency range in which the zero-phase angle impedance drew a semicircle.

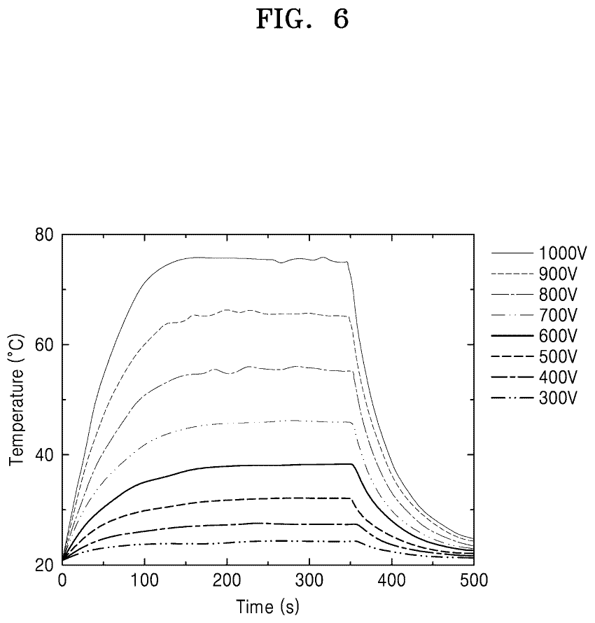

FIG. 6 is a graph showing heat generation characteristics according to an intensity of an alternating voltage according to an embodiment. PVC was used as a polymer network of a dielectric gel layer, and DBA was used as a plasticizer. A weight ratio of the plasticizer to the polymer network is at least about 4 but not more than about 8. An alternating voltage was applied to a dielectric gel layer with varying intensity under an operational frequency of about 100 Hz.

Referring to FIG. 6, it may be confirmed that heat generated in the dielectric gel layer was proportional to the intensity of voltage. For example, it may be confirmed that, when a voltage of about 600 V is applied, a saturation temperature of the dielectric gel layer is about 38 degrees, and when a voltage of about 1000 V is applied, the saturation temperature of the dielectric gel layer is about 75 degrees.

Also, it may be confirmed that the temperature of the dielectric gel layer no longer increased once the temperature of the dielectric gel layer reached a saturation temperature. In addition, it may be confirmed that a time to reach the saturation temperature was about 100 seconds, which was constant regardless of the intensity of the voltage.

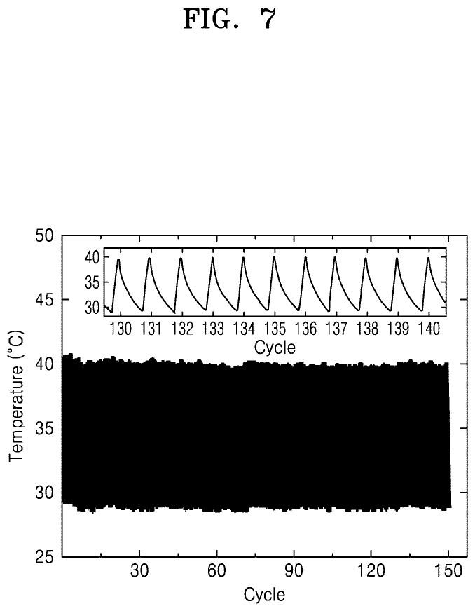

FIG. 7 is a result showing a temperature change when voltage is repeatedly applied to a dielectric gel layer according to an embodiment.

Referring to FIG. 7, when a voltage on the dielectric gel layer is periodically turned on/off, it may be confirmed that a non-heating temperature of the dielectric gel layer was about 30 degrees, and a saturation temperature was about 40 degrees. This indicates that a flexible heater according to an embodiment has excellent thermal stability.

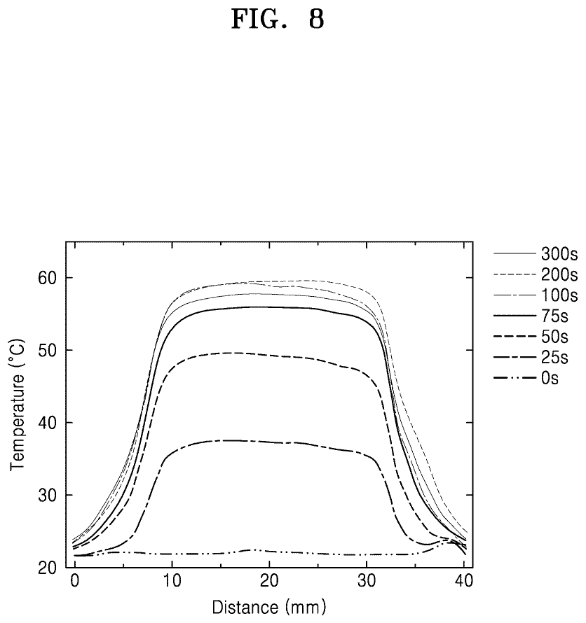

FIG. 8 is a graph showing temperature distribution for each position of a dielectric gel layer according to an embodiment. A square-shaped dielectric gel layer with a side length of 20 mm was placed in an area with a distance of 10 mm to 30 mm, and the temperature at each position over time was measured.

Referring to FIG. 8, it may be confirmed that, in about 100 seconds, the dielectric gel layer reached the saturation temperature at about 58 seconds. Also, it may be confirmed that the temperature was uniform throughout the dielectric gel layer while the dielectric gel layer is heated. It may be confirmed that a ratio of a minimum temperature to a maximum temperature of the dielectric gel layer in an area was about 0.8 or more.

Heat generated in the dielectric gel layer may not be prevented from being spread to an external environment. However, it may be confirmed that a temperature in an area with a distance of 0 mm to 10 mm and an area with a distance of 30 mm to 40 mm decreased rapidly as the distance from the dielectric gel layer increased. This means that the thermal conductivity of the dielectric gel layer is low, and thus heat diffusion is less. The thermal conductivity of the dielectric gel layer according to an embodiment may be about 0.5 W/mk or less.

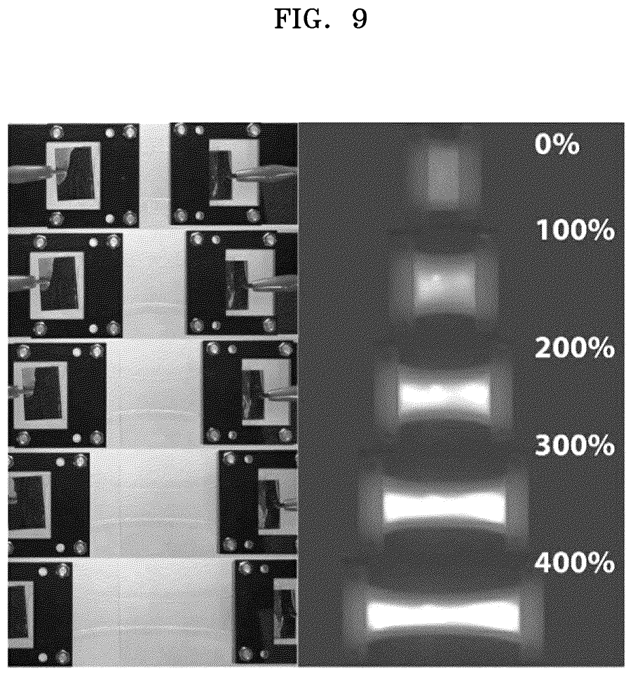

FIG. 9 is a diagram showing thermal characteristics according to a strain rate of a flexible heater according to an embodiment. A dielectric gel layer was a PVC gel layer, and electrodes were formed with a conductive hydrogel on lower and upper surfaces of the dielectric gel layer. After applying an alternating voltage with a frequency of about 100 Hz and an intensity of about 600 V, the strain rate of the flexible heater was changed in units of 100%.

Referring to FIG. 9, tensile stress was applied to both ends of the flexible heater so that the strain rate of the flexible heater was 0%, 100%, 200%, 300%, and 400%. It may be confirmed that the temperature was uniformly distributed throughout an entire area of the flexible heater even when the strain rate of the flexible heater was 400%.

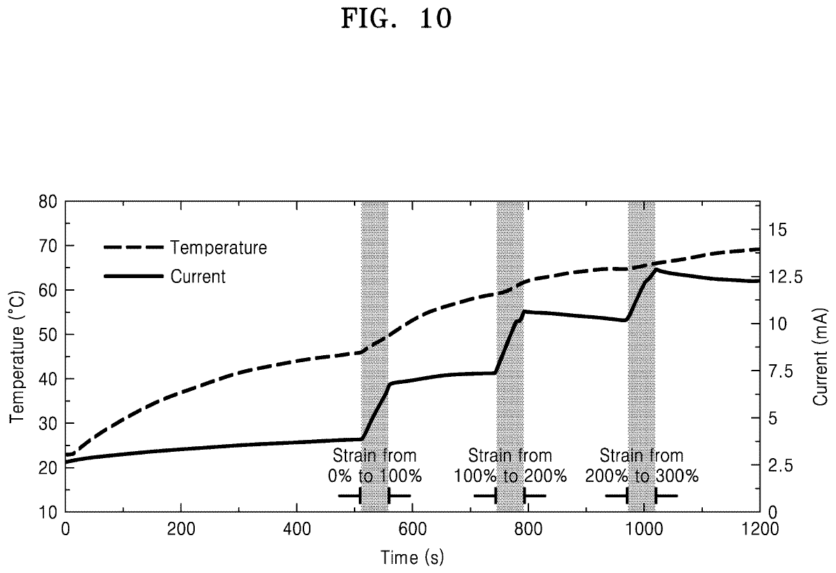

FIG. 10 is a graph showing temperature and current according to modification of a flexible heater according to an embodiment. As the strain rate of the flexible heater increases, a current flowing in a dielectric gel layer increases. This is because the thickness of the dielectric gel layer decreases as the dielectric gel layer is stretched long, and thus an intensity of an electric field increases.

Also, it may be confirmed that a temperature change according to tensile stress was not significant when the strain rate of the flexible heater was 200% or more. Accordingly, the temperature of the dielectric gel layer may be maintained at an appropriate temperature by adjusting an intensity of an applied alternating voltage according to the strain rate of the dielectric gel layer.

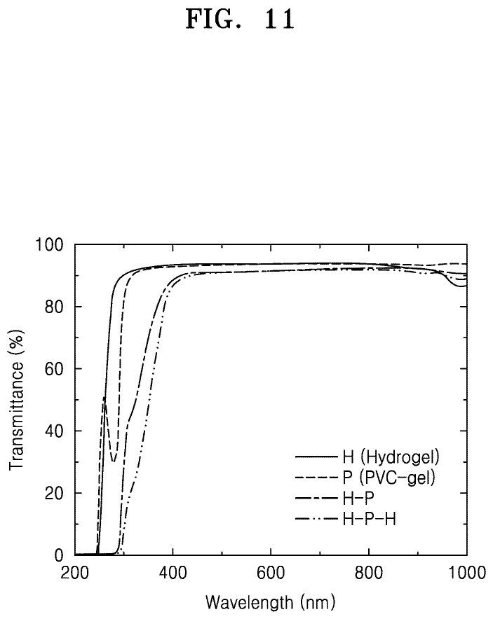

FIG. 11 is a graph showing permeability of a flexible heater according to an embodiment. In FIG. 11, ‘H’ refers to an electrode formed of a conductive hydrogel, ‘P’ refers to a dielectric gel layer including a plasticizer, and ‘H—P’ refers to a case where an electrode of a conductive hydrogel was arranged only on one surface of a dielectric gel layer including dipoles. Also, ‘H—P—H’ means that electrodes of the conductive hydrogel were arranged on both surfaces of the dielectric gel layer including dipoles.

Referring to FIG. 11, it may be confirmed that the dielectric gel layer, the electrode of the conductive hydrogel, and a flexible heater including the dielectric gel layer and the electrode of the conductive hydrogel all had a transmittance of about 85% or more in a range of about 390 nm to about 780 nm, which is a visible light area.

The flexible heater according to an embodiment may also locally generate heat only in a partial area of the dielectric gel layer. This is because the thermal conductivity of the dielectric gel layer is low.

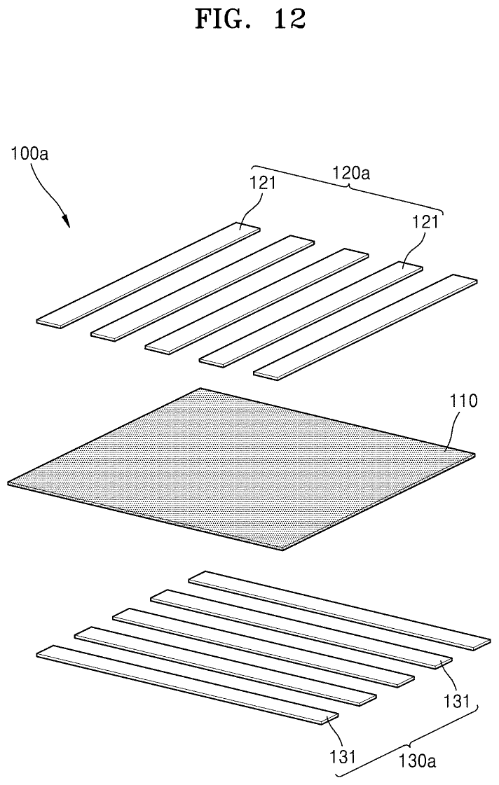

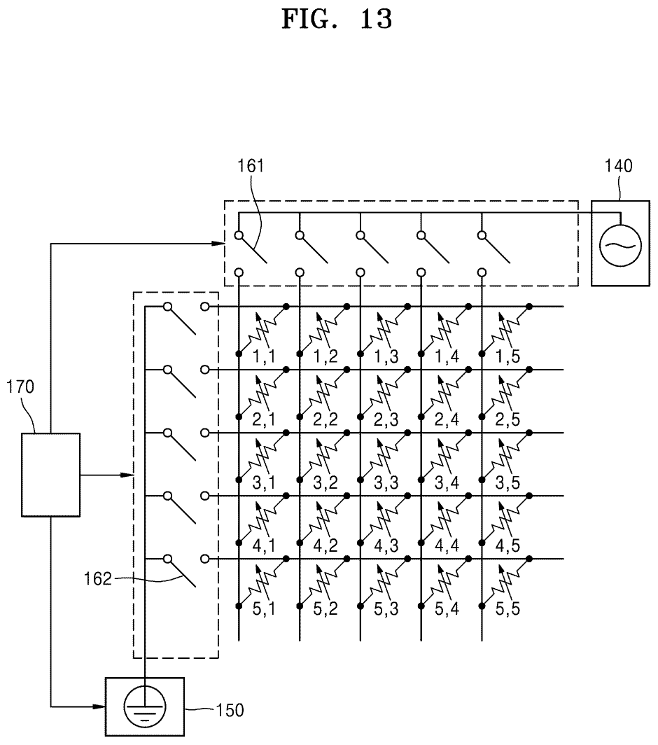

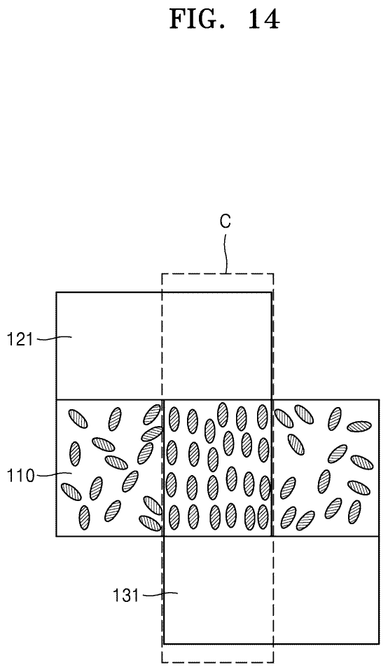

FIG. 12 is a diagram showing a flexible heater 100a that generates heat locally according to an embodiment, FIG. 13 is a block diagram including an equivalent circuit of the flexible heater 100a shown in FIG. 12, and FIG. 14 is a diagram showing a partial area including unit cells C included in the flexible heater of FIG. 12.

As shown in FIG. 12, the flexible heater 100a may include the dielectric gel layer 110, a first electrode 120a, and a second electrode 130a, wherein the first electrode 120a and the second electrode 130a are arranged to be spaced apart from each other with the dielectric gel layer 110 therebetween. The materials of the dielectric gel layer 110 and the first and second electrodes 120a and 130a are as described in FIG. 1, and detailed descriptions thereof are omitted.

The first electrode 120a may include a plurality of first sub-electrodes 121 arranged to be spaced apart from each other in a first direction (e.g., an X axis direction or a row direction), and the second electrode 130a may include a plurality of second sub-electrodes 131 arranged to be spaced apart from each other in a second direction (e.g., a Y axis direction or a column direction). The second direction may be perpendicular to the first direction. However, the disclosure is not limited thereto. The second direction may be a direction crossing the first direction without being perpendicular to the first direction. FIG. 12 illustrates a structure in which the plurality of first sub-electrodes 121 and the plurality of second sub-electrodes 131 are arranged in a 5×5 arrangement, but the disclosure is not limited thereto. The number and spacing of the first and second sub-electrodes 121 and 131 may vary according to the purpose of the flexible heater 100a.

The first sub-electrode 121, a dielectric cell, and the second sub-electrode 131, which overlap in a thickness direction of the dielectric gel layer 110, may be referred to as a unit cell C.

FIG. 13 is a block diagram including an equivalent circuit of the flexible heater 100a shown in FIG. 12, where the unit cell C is represented by a variable resistor. Heat generation of the unit cell C may be controlled according to a connection method of rows and columns.

In an embodiment, the flexible heater 100a may include a driver 140 that applies a driving signal, for example, an alternating voltage, to each of the plurality of first sub-electrodes 121, a ground unit 150 that applies a ground signal to each of the plurality of second sub-electrodes 131, a plurality of first switching elements 161 electrically turning on or off each of the plurality of first sub-electrodes 121 and the driver 140, and a plurality of second switching elements 162 electrically turning on or off each of the plurality of second sub-electrodes 131 and the ground unit 150. In an embodiment, the flexible heater 100 may further include a controller 170 controlling the driver 140 and the plurality of first an second switching elements 161 and 162.

Each of the plurality of first sub-electrodes 121 may be connected to the driver 140 through a first switching element 161, and each of the plurality of second sub-electrodes 131 may be connected to the ground unit 150 through a second switching element 162. In the drawing, it is shown that one driver 140 is electrically connected to the plurality of first sub-electrodes 121, but the disclosure is not limited thereto. The driver 140, which is electrically connectable, may also be arranged on each of the plurality of first sub-electrodes 121, or some of the first sub-electrodes 121 may be grouped and electrically connected to one driver 140.

A resistance of the dielectric gel layer 110 included in the unit cell C is much greater than resistances of the first and second sub-electrodes 121 and 131, so that heat may be generated only in the dielectric gel layer 110 of the unit cell C.

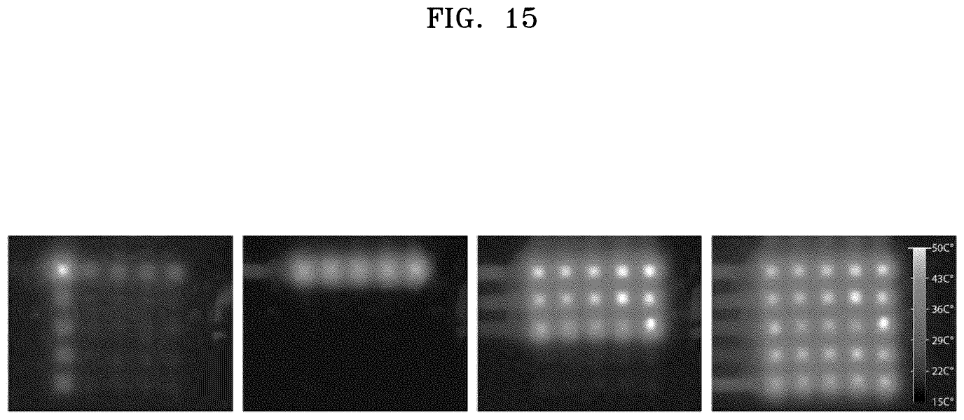

FIG. 15 is a diagram showing results of an experiment after manufacturing the flexible heater of FIG. 12. As shown in FIG. 15, it may be confirmed that, when an alternating voltage is applied to a particular unit cell by using first and second switching elements, the particular unit cell may selectively generate heat.

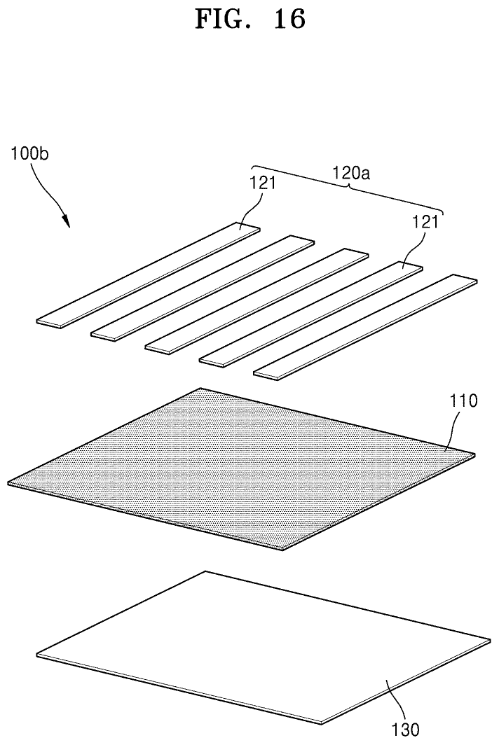

FIG. 16 is a diagram illustrating a flexible heater 100b including a sub-electrode according to an embodiment. As FIG. 16 is compared with FIG. 12, a first electrode 120a included in the flexible heater 100b of FIG. 16 may include a plurality of first sub-electrodes 121 arranged to be spaced apart from each other, and the second electrode 130 may be formed as one layer. The flexible heater 100b of FIG. 16 may have continuous heat generation characteristics as compared to the flexible heater 100a of FIG. 12.

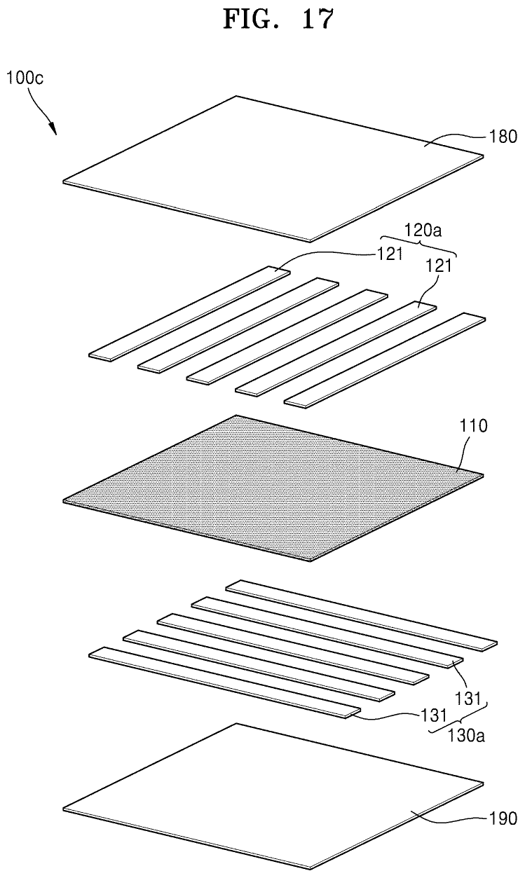

FIG. 17 is a diagram illustrating a flexible heater 100c including an insulating layer according to an embodiment. As FIG. 17 is compared with FIG. 12, the flexible heater 100c of FIG. 17 may further include a first insulating substrate 180 on an upper surface of the first electrode 120a and a second insulating substrate 190 arranged on a lower surface of the second electrode 130a. Each of the first and second insulating substrates 180 and 190 may also include a flexible material. For example, like the dielectric gel layer 110, at least one of the first and second insulating substrates 180 and 190 may include a polymer network and a plasticizer. Alternatively, at least one of the first and second insulating substrates 180 and 190 may also be an insulating hydrogel. However, the disclosure is not limited thereto. The first and second insulating substrates 180 and 190 may also include any transparent insulating materials.

In an embodiment, each of the flexible heaters 100, 100a, 100b, and 100c has a high strain rate and may generate heat locally, and thus the flexible heaters 100, 100a, 100b, and 100c may be applied to a thermal haptic device that may be attached or worn on the skin. Each of the flexible heaters 100, 100a, 100b, and 100c according to an embodiment may generate heat even at a high strain rate, and thus the flexible heaters 100, 100a, 100b, and 100c may be installed and used in areas of the human body, the areas having large strain. For example, the flexible heaters 100, 100a, 100b, and 100c may also be worn in areas where deformation is close to 100%, such as an elbow.

In an embodiment, the flexible heaters 100, 100a, 100b, and 100c may also be used as heat therapy devices or heat massage devices. For example, a heat massage device may be possible by wearing the flexible heaters 100, 100a, 100b, and 100c on an area with muscle pain or fatigue. Alternatively, when heat treatment is performed on a wounded part of the skin, because the flexible heaters 100, 100a, 100b, and 100c are transparent, a user may receive treatment by generating local heat only on the wounded part while directly checking the wounded part with the naked eye.

In an embodiment, the flexible heaters 100, 100a, 100b, and 100c may also be applied to robots or thermal and visual displays.

A flexible heater has been merely illustrative, and those skilled in the art will understand that various modifications and other equivalent embodiments are possible therefrom. Although many details are described in the above description, the details should be interpreted as particular embodiments rather than limiting the scope of the disclosure. Therefore, the scope should not be determined by the described embodiments, but rather be determined by the technical idea described in claims.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A flexible heater comprising:
a first electrode;
a second electrode arranged to be spaced apart from the first electrode; and
a dielectric gel layer arranged between the first electrode and the second electrode and generating heat in response to an alternating voltage applied thereto,
wherein the dielectric gel layer has a dielectric loss value of 10 or more at an frequency of the alternating voltage of 1,000 Hz or less.

2. The flexible heater of claim 1, wherein the dielectric gel layer comprises a polymer network and plasticizers dispersed in the polymer network.

3. The flexible heater of claim 2, wherein the polymer network comprises at least one of a co-polymer and a block co-polymer of polyvinyl chloride (PVC)-based, polystyrene (PS)-based, polymethyl methacrylate (PMMA)-based, polyvinylidene fluoride-based, polybutene (PB)-based.

4. The flexible heater of claim 2, wherein the plasticizers comprise at least one of dibutyl adipate (DBA), dimethyl phthalate(DMP), diethyl phthalate (DEP), dibutyl phthalate (DBP), bis(2-ethylhexyl) phthalate (DEHP), diisodecyl phthalate (DIDP), diisononyl phthalate (DINP), bis(2-ethylhexyl) terephthalate (DOTP), diisodecyl adipate (DIDA), dimethyl adipate(DMA), dietyl adipate (DEA), dipropyl adipate (DPA), bis(2-ethylhexyl)adipate (DOA), diisopropyl adipate (DIPA), dacetyl tributyl citrate (ATBC), dibutyl sebacate (DBS), dioctyl sebacate (DOS), dioctyl Maleate (DOM), 1,2-Cyclohexane dicarboxylic acid diisononyl ester (DINCH) and tris(2-ethylhexyl)trimellitate (TOTM).

5. The flexible heater of claim 2, wherein a weight of the plasticizers in the dielectric gel layer is greater than a weight of the polymer network.

6. The flexible heater of claim 2, wherein a weight ratio of the plasticizers to the polymer network is greater than 2 and 14 or less.

7. The flexible heater of claim 2, wherein the dielectric gel layer generates heat by a periodic movement of the plasticizers in the dielectric gel layer in response to the alternating voltage applied thereto.

8. The flexible heater of claim 7, wherein the movement of the plasticizers comprises at least one of a rotational movement, a vibration movement, and a linear movement of the plasticizers.

9. The flexible heater of claim 1, wherein the dielectric gel layer has a thermal conductivity of 0.5 W/mk or less.

10. The flexible heater of claim 1, wherein a temperature of the dielectric gel layer no longer increases once the temperature of the dielectric gel layer reaches a saturation temperature.

11. The flexible heater of claim 10, wherein, when an operational frequency of the alternating voltage is a frequency of a zero-phase angle impedance or more, the saturation temperature is proportional to an intensity of the alternating voltage regardless of the operational frequency of the alternating voltage.

12. The flexible heater of claim 11, wherein the frequency of the zero-phase angle impedance is comprised in a range of at least 10 Hz but not more than 1,000 Hz.

13. The flexible heater of claim 1, wherein a ratio of a minimum temperature to a maximum temperature in an area of the dielectric gel layer is 0.8 or more.

14. The flexible heater of claim 1, wherein at least one of the first and second electrodes comprises at least one of a conductive hydrogel, a conductive oxide, a carbon-based conductive material, a conductive polymer, and a metal.

15. The flexible heater of claim 14, wherein at least one of the first and second electrodes comprises at least one of a conductive particle and an electrolyte.

16. The flexible heater of claim 14, wherein at least one of the first and second electrodes further comprises a crosslinking agent that is covalently cross-linked with the dielectric gel layer.

17. The flexible heater of claim 1, wherein the flexible heater has a light transmittance of 70% or more in a visible light area.

18. The flexible heater of claim 1, wherein a strain rate of the flexible heater is 100% or more.

19. The flexible heater of claim 1, wherein the first electrode comprises a plurality of first sub-electrodes arranged to be spaced apart from each other in a first direction, and
the dielectric gel layer selectively generates heat in an area overlapping the plurality of first sub-electrodes and the second electrode in a thickness direction of the dielectric gel layer.

20. The flexible heater of claim 1, wherein the second electrode comprises a plurality of second sub-electrodes arranged to be spaced apart from each other in a second direction that is different from the first direction.
